(19) United States
(12) Patent Application Publication
(10) Pub. No.: US 2016/0020048 A1
(43) Pub. Date: Jan. 21, 2016

(54) MODULAR, CLEANABLE TACTILE SWITCH MECHANISM FOR USE IN ELECTRONIC PIPES AND OTHER "HEIRLOOM" ELECTROMECHANICAL APPLICATIONS

(71) Applicant: Kenneth Latham Ware, Tucker, GA (US)

(72) Inventor: Kenneth Latham Ware, Tucker, GA (US)

(73) Assignee: KENNETH LATHAM WARE, Tucker, GA (US)

(21) Appl. No.: 14/716,836

(22) Filed: May 19, 2015

Related U.S. Application Data
(60) Provisional application No. 62/001,256, filed on May 21, 2014.

(51) Int. Cl. H01H 36/00; A24F 1/00; A24F 47/00

(52) U.S. Cl. CPC H01H 36/004; A24F 47/008; A24F 1/00; H01H 2215/00

(57) ABSTRACT

A modular, cleanable, tactile switch mechanism is developed for use in an electronic pipe style personal vaporizer. The mechanism includes magnets and a pivoting arm of magnetically active material along with a customizable base that supports and guides these interacting parts. In the electronic pipe implementation of this mechanism, guiding niches of the base are integrated with a larger core support structure, demonstrating its versatility and ability to reduce overall enclosure footprint under some circumstances. Additionally, the pipe system features a locking mechanism which allows easy disassembly and repair of hand carved or otherwise fragile devices without risk of damage.

The present invention relates primarily to the field of magnetic or mechanical switches, particularly those capable of providing tactile feedback in a compact, durable configuration. Additionally, the invention relates to miscellaneous spring devices as well as tobacco substitute products and components thereof.

### BACKGROUND OF THE INVENTION

As personal vaporizers, otherwise known as simulated smoking devices or electronic cigarettes, have increased in popularity over recent years, various problems have been identified and addressed. One key issue has been particularly prominent in this evolution. Batteries of an approximately cigarette size are generally too weak and must be recharged too often to provide a satisfactory user experience. This has led to the development of larger, cigar style and pipe style, devices. More advanced or high-end units are hand-carved from exotic woods and designed to accept user-replaceable cells. This unique integration of fine art and consumer electronics has created demand for a switch which generally meets the requirements of being compact and durable with strong tactile feedback. However, due to the carved, wooden, nature of these devices common tactile switches present some unique problems with installation. Because the pushbutton must extend through a wooden body, it must be larger than normal, and in some cases too large for normal installation.

The demand for durability in this market often manifests as a desire for user maintainable devices. Demand for stronger than average tactile response is part of a broader trend toward preserving qualities of traditional ‘tobacciana.’ However, the constraints on size are perhaps most restrictive. Within the field of simulated smoking devices it is preferred that overall device size remain within dimensions roughly equivalent to traditional tobacco pipes or cigars. This constraint along with the limited energy density of available batteries leaves minimal room for a switch and required circuitry.

Where a strong tactile response is required, switch manufacturers have traditionally relied upon a flexing metal dome. This type of switch however, does not exhibit the type of long term durability that is desired for this application. As the metal dome repeatedly flexes it becomes worn and eventually fails. There are alternative designs known in the art which instead employ magnetic attraction to create the desired tactile sensations. However, these also fall short of the ideal in some areas of concern to our particular objective.

U.S. Pat. No. 5,990,772 describes a pushbutton switch with a magnetically coupled armature, however the design disclosed is specialized for membrane type switches and requires some specialized parts which increase manufacturing costs. U.S. Pat. No. 6,556,112 describes a method for making a discrete magnetically coupled pushbutton switch. It is essentially an adaptation of the same magnetically coupled armature for those applications where a dome style tact switch would traditionally be used. This latter design has a smaller surface area and includes solder tabs for mounting on a printed circuit board, however it also requires many specialized parts and is not ideal for use in very small spaces. Neither these designs nor the traditional dome tact switch meets all of our requirements for the present application.

### BRIEF SUMMARY OF THE INVENTION

The present invention is a modular, tactile, mechanism comprising: an armature of magnetically active material; a supporting magnet which also acts as a fulcrum for the armature; a customizable supporting structure with guiding niches for the interacting parts; along with a modular, customizable point of user activation to ease manual pivoting of the armature for tactile effect while accomplishing some simple mechanical task, such as closing a circuit. Such a mechanism is ideal for use by hobbyists and craftsmen who require durability and versatility along with a quality tactile response to compliment their hand crafted, heirloom style products.

A primary object of the invention is a modular, cleanable tactile switch mechanism, further comprising two or more electrical contacts with the tactile mechanism being used to alter continuity between them. This type of switch can be manufactured inexpensively and adapted easily to suit a variety of applications where strong tactile feedback and long term durability are required. A further object is an electromechanical platform for development of electronic pipes or conversion of traditional pipes for use with personal vaporizers, comprising: a supporting core with locking cap; a modular, cleanable tactile switch positioned on the side of that core; a locking mechanism which secures the core within the pipe cavity, easing disassembly and maintenance; along with the requisite electronics to power a device of the user's choosing. In many respects a pipe style device is better suited to the unique demands of personal vaporizers. Even with a large battery housed in the chamber of an electronic pipe, the device sits comfortably in hand, lending a more natural and traditional feel to the experience.

The pushbutton or point of user activation in any case must be long enough to extend through device walls, which may often be substantial for structural or purely decorative reasons. This can pose significant installation problems, particularly for those switches most commonly available. It is preferable therefore that the pushbutton be detachable from the rest of the switch mechanism. This added modularity will make it possible to install the switch and other components in confined spaces while still allowing for sufficiently robust enclosure walls. As an added benefit, this means that the point of activation can also be customized and even matched to a particular wood.

The principal mechanism of the present invention, includes an armature which sits partially on a magnet or magnets while also overhanging substantially in the opposite direction. The armature is formed of a conductive and magnetically active material. It is retained in the described position by its attraction to the magnet(s). Additionally, the magnets are supported and the armature is partially enclosed by a molded base which may also include niches for electrical contacts to be attached under the magnets and under the opposite end of the armature. The centrally located magnet acts both as retainer and fulcrum for the armature which may pivot about its point of contact with that magnet. This pivoting can be used to open or close electrical circuits or for other purely mechanical tasks such as releasing a latch.

Due to its simplicity, the apparatus described can be inexpensively produced, even in small quantities when necessary. The armature can be formed into a shape appropriate for its task and the base can be produced as a discrete module or integrated structurally with other components of a particular implementation. This apparatus can then be installed in an enclosure where it should align with an opening adjacent to the magnets and slightly off center of the armature lengthwise. Through this opening, a suitable pushbutton can be attached magnetically to the armature to allow activation. It is this simplicity and modularity which significantly distinguish the present invention from what is known in the art.

When implemented as a switch, the present design has the added advantage of being easily cleanable. Hence it may be expected to endure a long life of heavy use with little degradation. Furthermore, the electromechanical pipe system developed here will provide traditional pipe makers an easy means of entering the personal vaporizer market with quality mechanisms to compliment their craftsmanship.

### BRIEF DESCRIPTION OF THE SEVERAL VIEWS OF THE DRAWINGS

FIG. 1 is an exploded perspective view of a tactile mechanism according to the present invention.

FIG. 2 is an assembled perspective view of the mechanism of FIG. 1.

FIG. 3 is an assembled cross section of the mechanism of FIG. 1.

FIG. 4 is an assembled cross section of the mechanism of FIG. 1 in its actuated state.

FIG. 5 is an exploded perspective view of a tactile switch based on the mechanism of FIG. 1.

FIG. 6 is an assembled perspective view of the switch of FIG. 5.

FIG. 7 is an exploded perspective view of an electronic pipe according to the present invention.

FIG. 8 is an assembled perspective view of an electronic pipe according to the present invention.

FIG. 9 is a perspective view of core support 42

FIG. 10 is an assembled perspective view of core support 42

FIG. 11 is a bottom perspective view of core support 42

FIG. 12 is an assembled bottom perspective view of core support 42

FIG. 13 is an assembled perspective view of the interior of core support 42 with spring bracket 56.

FIG. 14. is a perspective view of the switch mechanism niches integrated within core support 42.

FIG. 15 is an assembled perspective view of the switch implementation within core support 42.

FIG. 16 is a perspective view of lock cylinder 66 and connector 70.

FIG. 17 is a perspective view of the pipe system components partially assembled, without pipe body 40.

FIG. 18 is a perspective view of the system components assembled without pipe body 40.

FIG. 19 is an overhead perspective view of the core interior.

FIG. 20 is an assembled perspective view of the core cap.

FIG. 21 is an overhead perspective view of the cap.

### DETAILED DESCRIPTION OF THE INVENTION

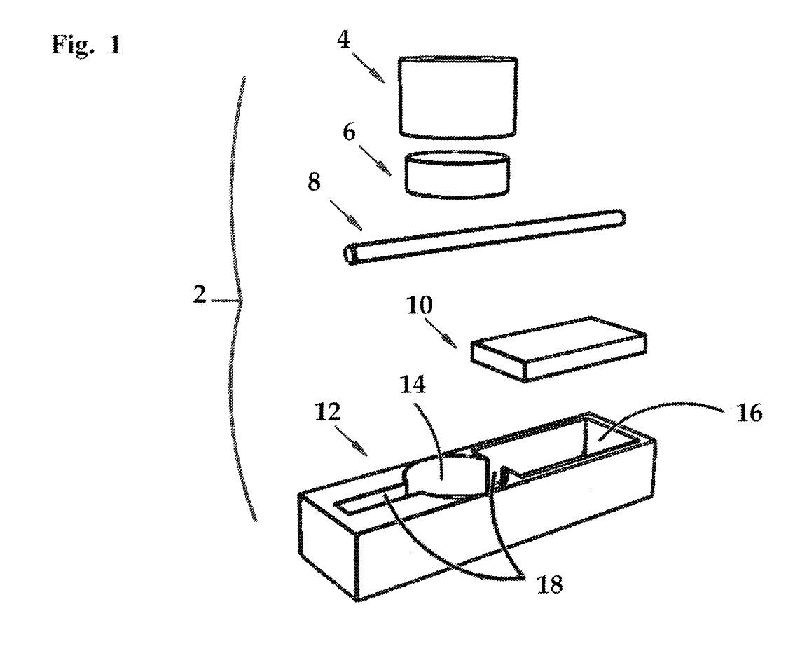

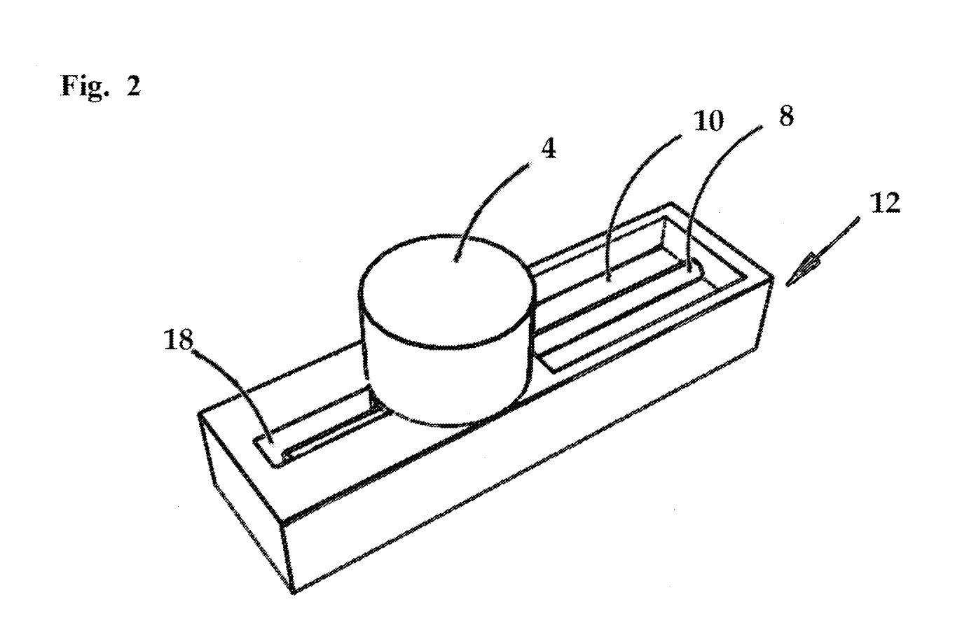

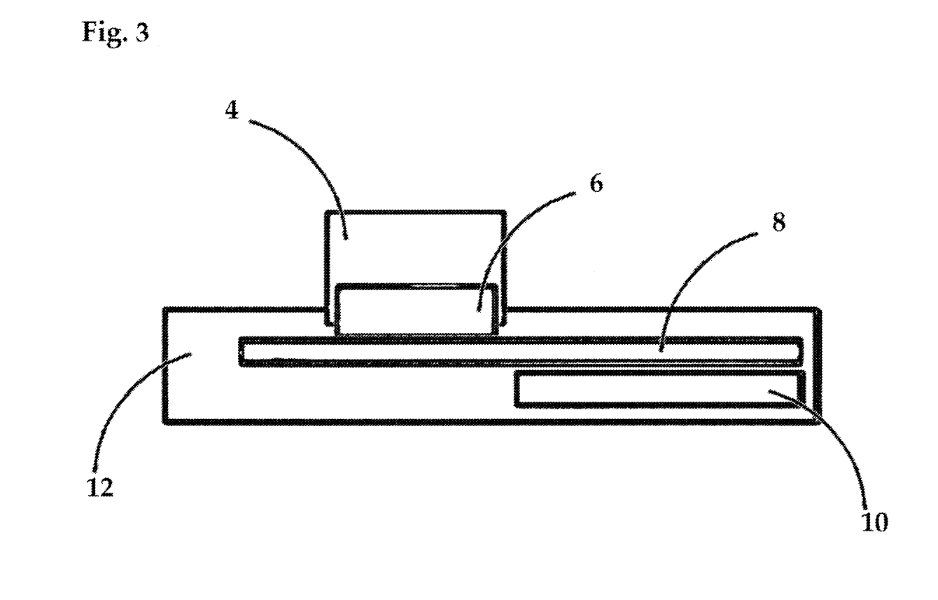

As seen in FIGS. 1 and 2, the tactile mechanism of the present invention shown generally at 2, requires a button 4 and attaching magnet 6, an armature of magnetically active material 8, a fulcrum magnet 10, and a molded base 12 which supports and guides the foregoing parts. FIGS. 1 through 5 show how the tactile mechanism of the present invention might appear in one of its simplest embodiments.

Pushbutton 4 should include a recess on bottom into which attaching magnet 6 can be pressed and fastened. In a preferred embodiment pushbutton 4 is cut from wood. It could also be rubber, plastic or any similar material. Fulcrum magnet 10, is pressed and fastened into niche 16 of molded support base 12. In a preferred embodiment, molded support base 12 is additively manufactured from plastic. It could be made from wood, ceramic, glass, or other non-conductive material. Armature 8, made of a magnetically active material, is then positioned on top of fulcrum magnet 10 where it is retained magnetically within niche 18. Pushbutton 4, along with magnet 6, is then inserted into guide niche 14 where it attaches to armature 8 magnetically.

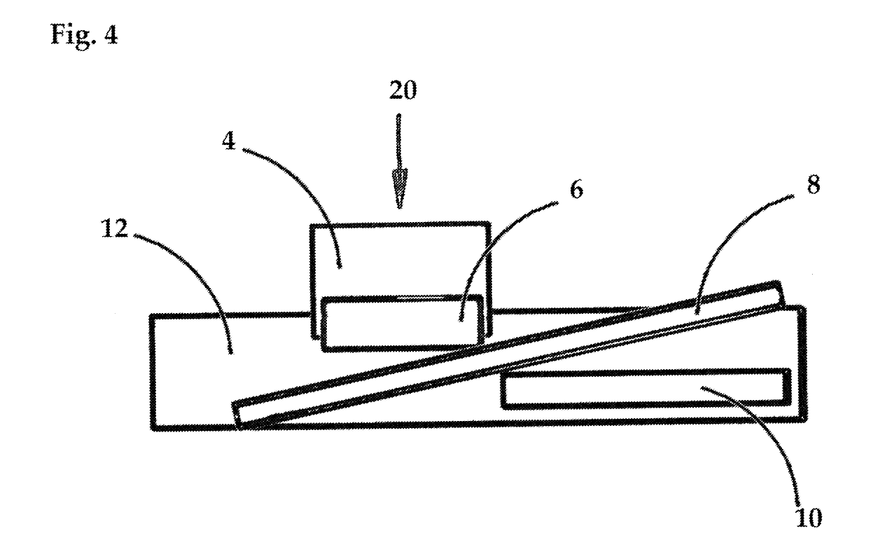

When downward actuating force 20 is applied by the user to pushbutton 4, as seen in FIG. 4, the pushbutton travels along with magnet 6, within guide niche 14 of molded base 12, transmitting the downward force to armature 8. This creates torque about the edge of fulcrum magnet 10 which, when sufficient, will cause the tail of armature 8 to overcome the magnetic attraction which holds it in its non-actuated position. When it does, the armature will quickly pivot until its front end strikes molded base 12 providing both tactile and auditory feedback and distributing the downward force between support base 12 and fulcrum magnet 10. This transmission of force to support base 12 could potentially be used for a number of purely mechanical purposes. In a preferred embodiment of the present invention it is used to open or close electrical circuits.

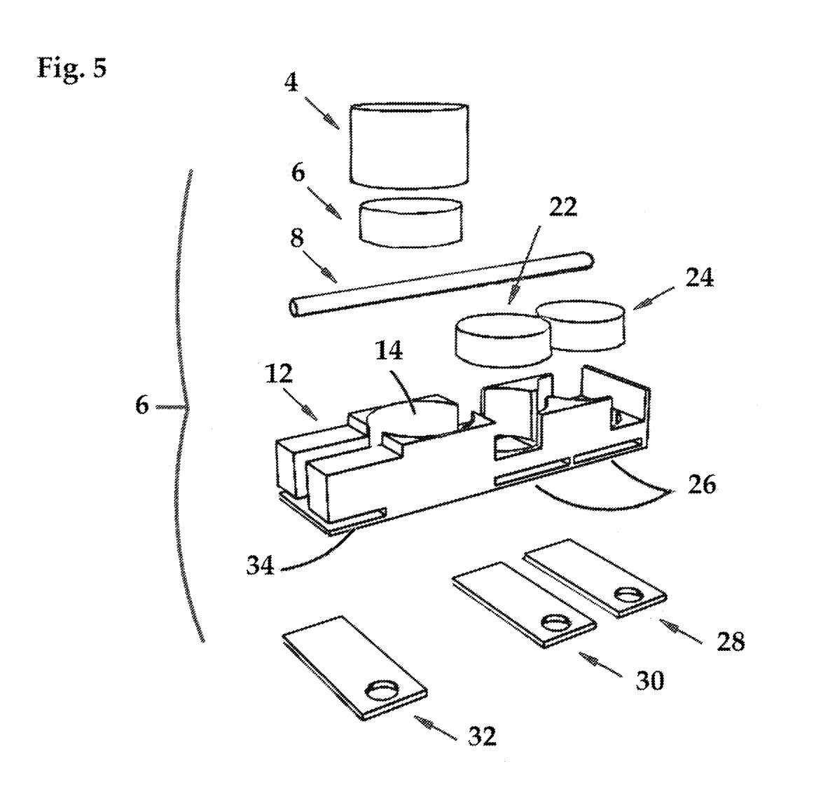

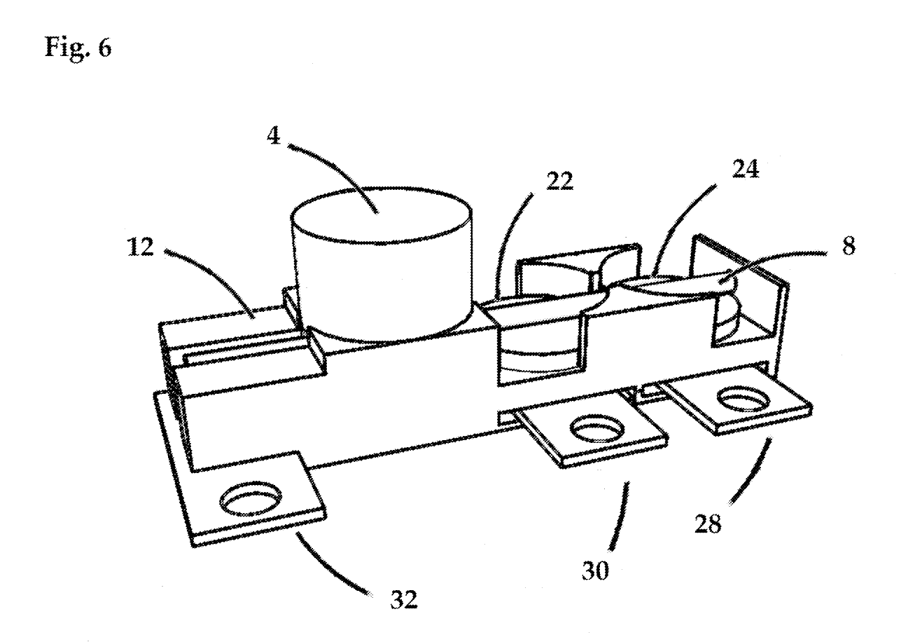

As seen in FIGS. 5 and 6 this preferred embodiment, shown generally at 6 is similar in construction to FIG. 2 though it includes several additional elements. Chiefly, the fulcrum magnet 10 has been replaced by two smaller magnets, fulcrum magnet 22 and retainer magnet 24. These are identical to attaching magnet 6. Under these magnets are fastened corresponding electrical contacts; fulcrum common contact 30 and normally closed contact 28 within niches 26 . Similarly, a normally open contact plate 32 is added to the point of contact between armature 8 and support base 12. These three contacts should be pressed or cut from a conductive, magnetically active material. Additionally, molded support base 12 should be of an insulating material and include the requisite niches to accommodate and/or guide each of the foregoing components.

Fulcrum magnet 22 and retainer magnet 24 must remain electrically isolated but also each be electrically connected and mechanically fastened to the tops of fulcrum common contact plate 30 and normally closed contact plate 28 respectively. This can be accomplished magnetically, though the electrical connection could potentially benefit from a conductive epoxy. Normally open contact plate 32 must be fastened within niche 34 in such a way that it will remain stationary during actuation.

This arrangement of contacts and magnets allows for two distinct actions with regard to electrical continuity. Upon actuation, the circuit between common contact 30 and normally closed contact 28 shifts from a closed to an open state. Whereas the circuit between common contact 30 and normally open contact 32 shifts from an open state to a closed one.

When downward actuating force 20 is applied by the user to pushbutton 4 the pushbutton will travel along with magnet 6 within guide niche 14 of molded support base 12, transmitting downward force to armature 8. This creates torque about the edge of fulcrum magnet 22 and when sufficient will cause the tail of armature 8 to overcome the magnetic attraction which holds it to retainer magnet 24 opening the circuit between contacts 30 and 28. When this occurs, armature 8 will quickly pivot until its tip strikes normally open contact plate 32 completing the circuit with common contact 30. As in the case of the mechanism of FIG. 2, this striking will also serve to provide tactile and auditory feedback of the actuation.

Either of the embodiments described thus far can be integrated structurally with a variety of applications allowing for implementation under very tight spatial constraints. It is only necessary to include the niches and guides of molded support base 12 in the structural design of an application and later add the remaining components in order to arrive at this fully integrated and extremely compact implementation.

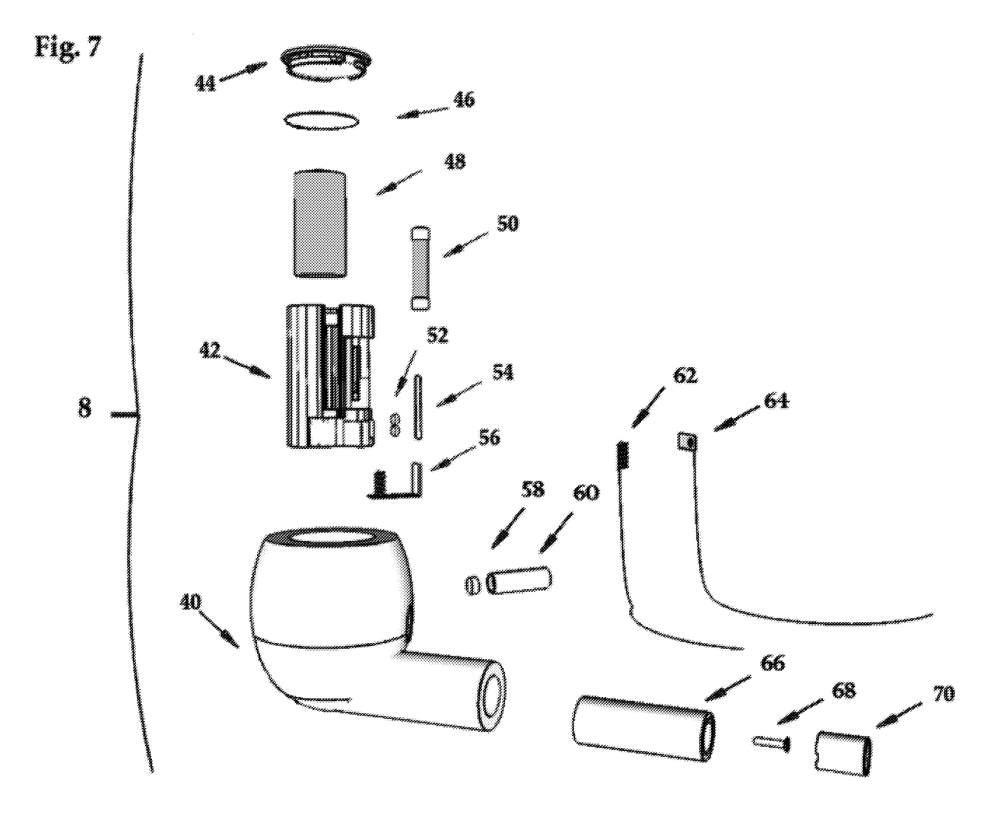

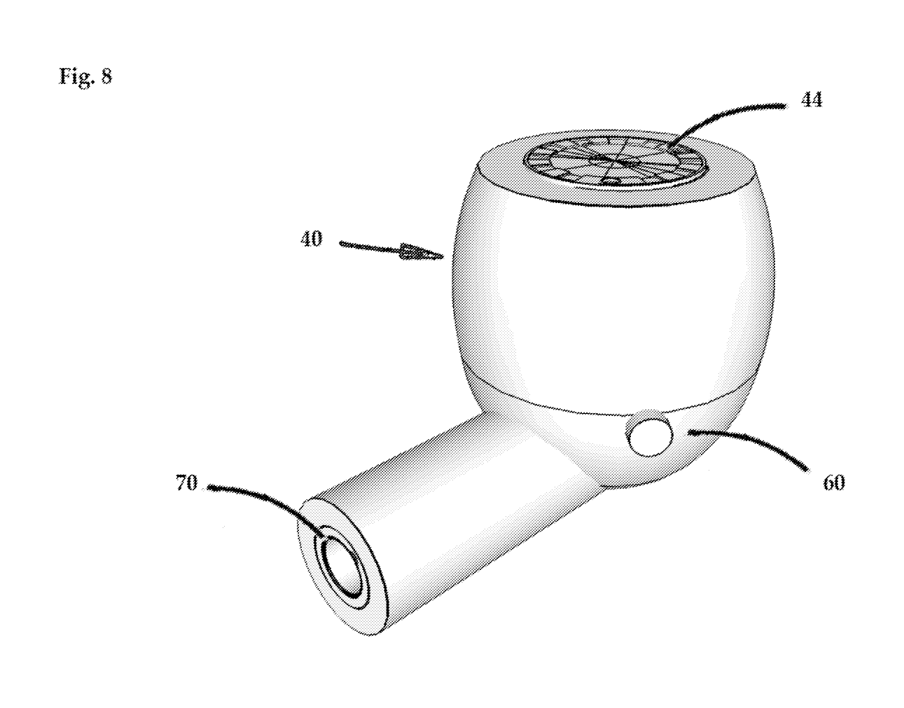

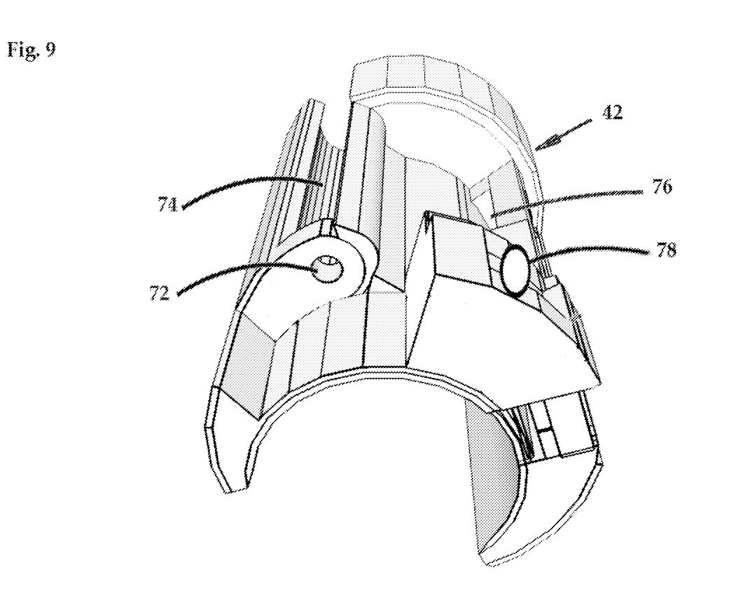

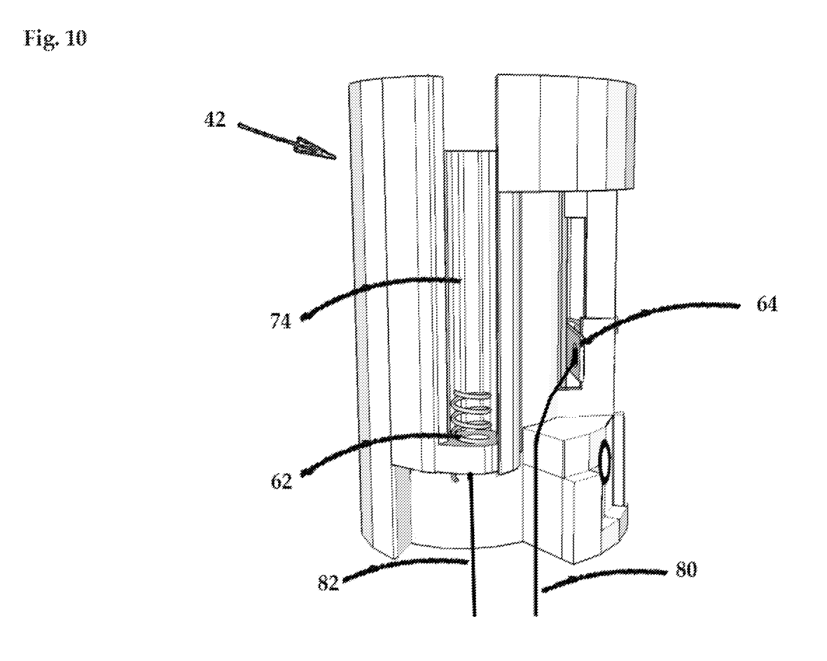

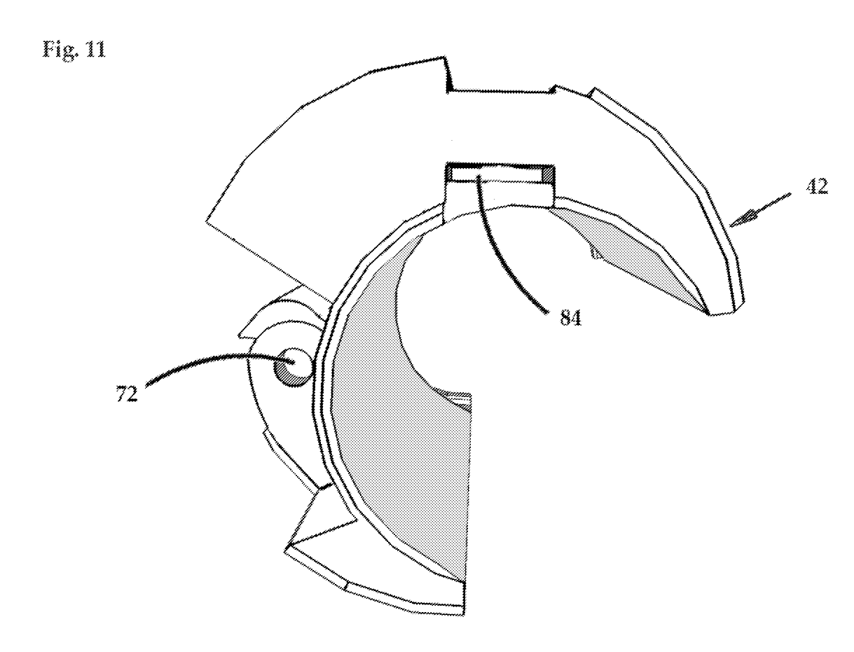

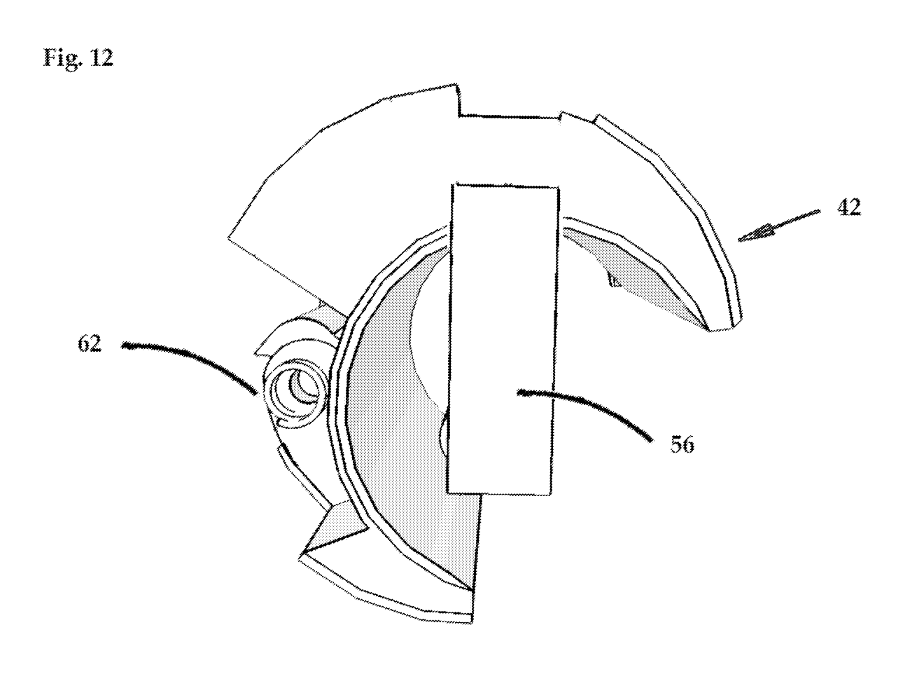

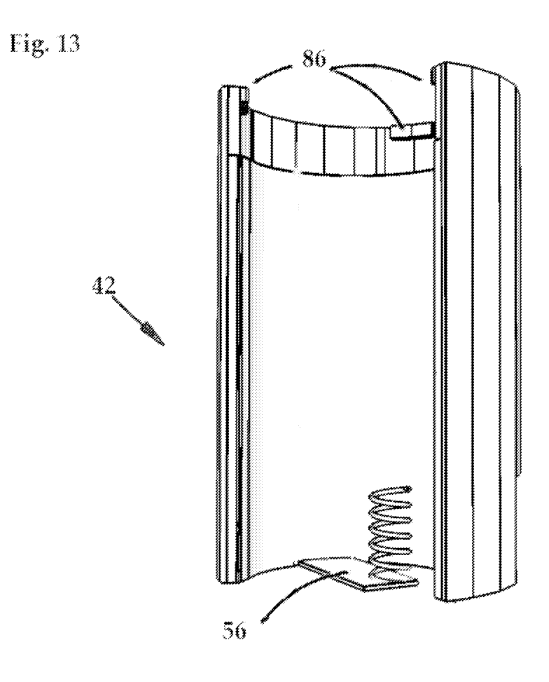

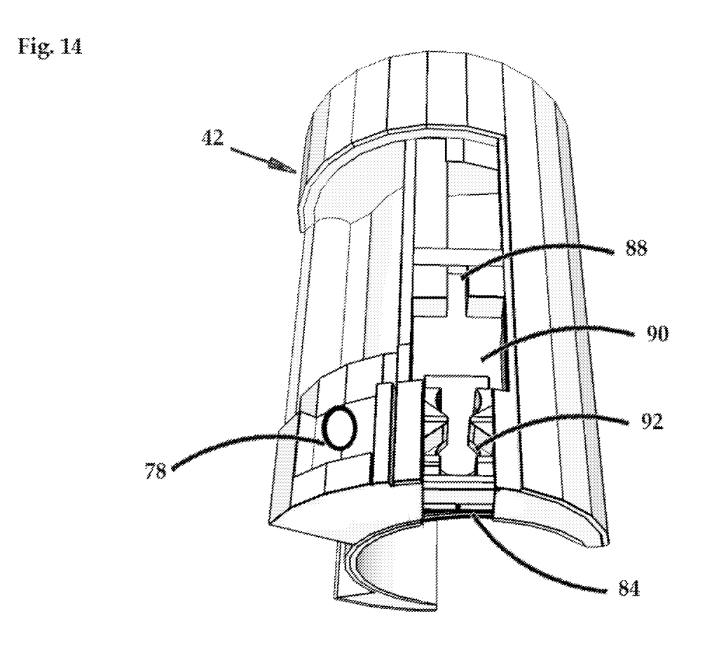

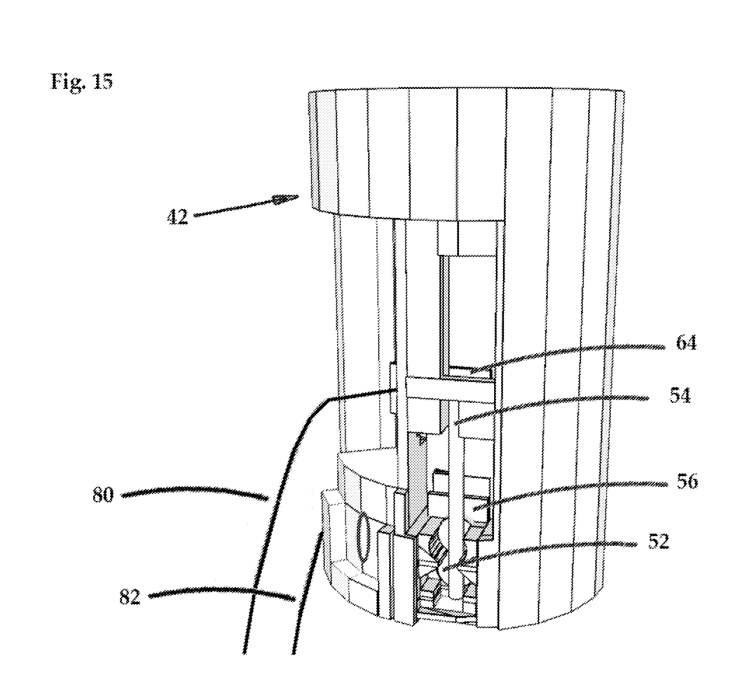

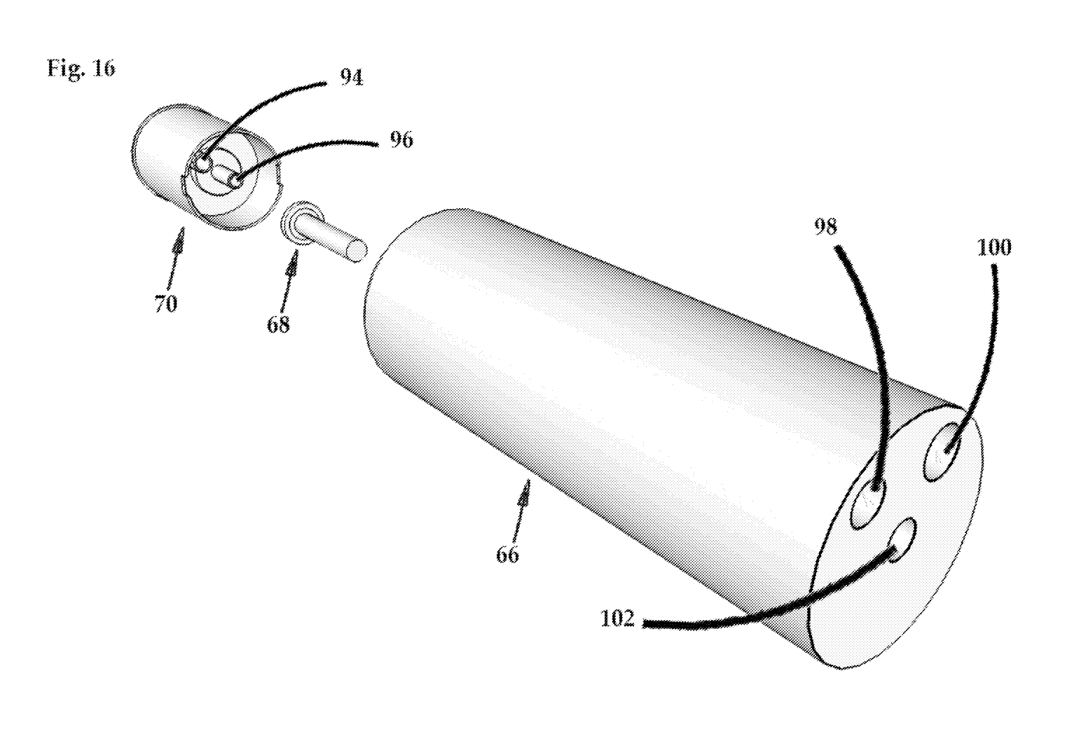

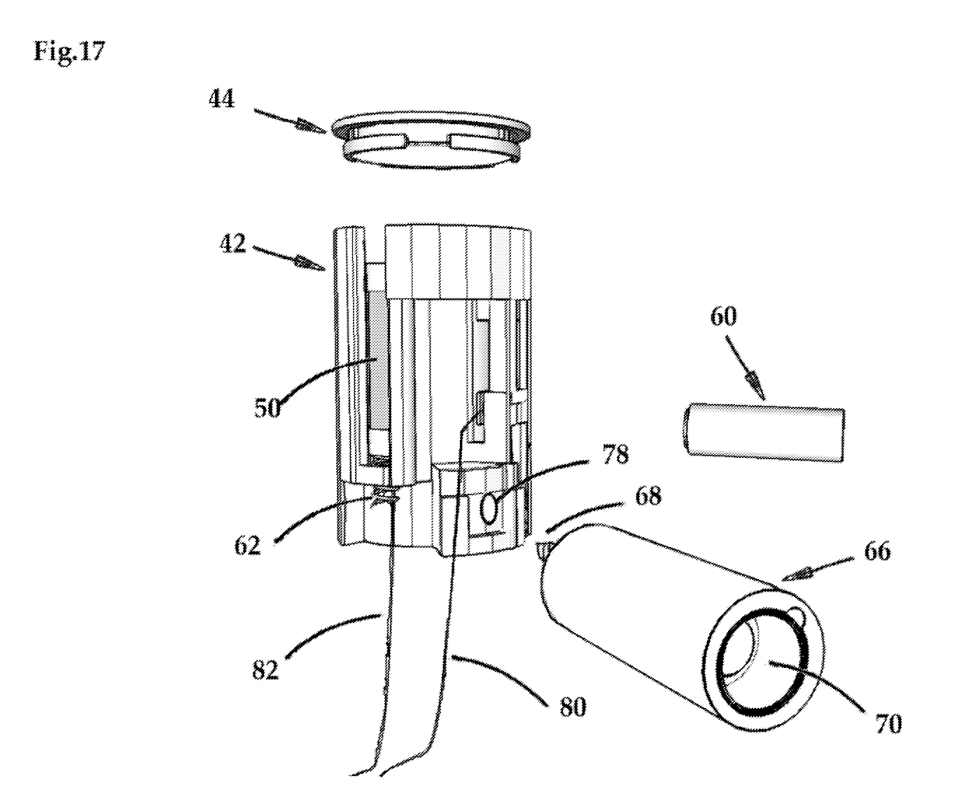

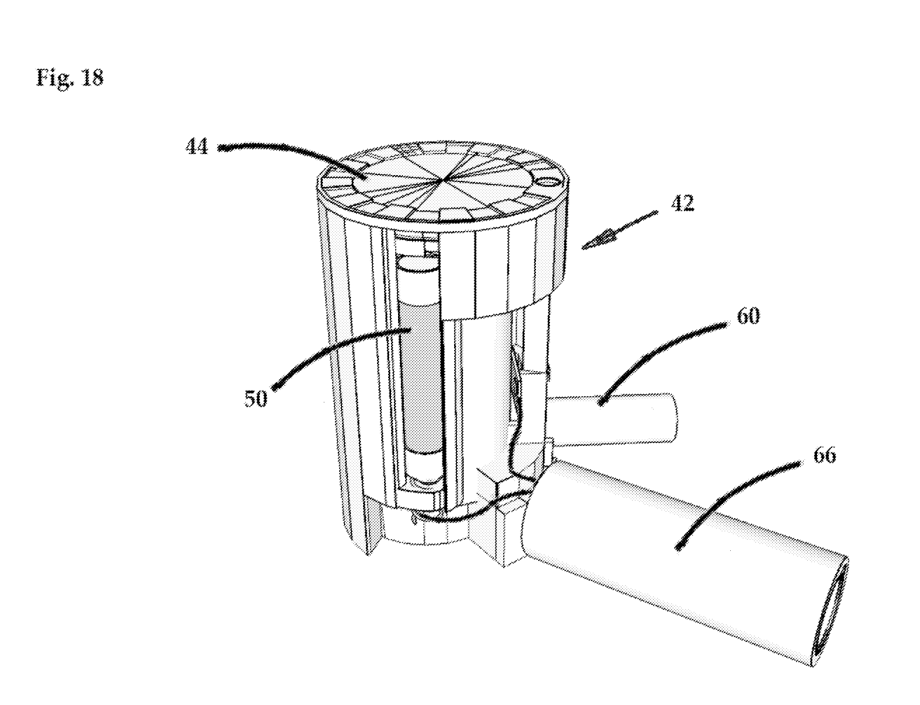

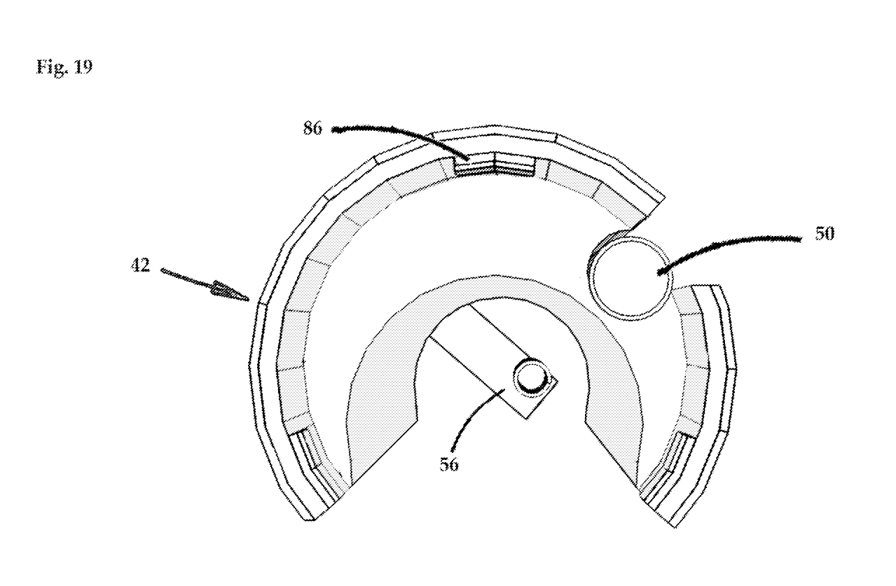

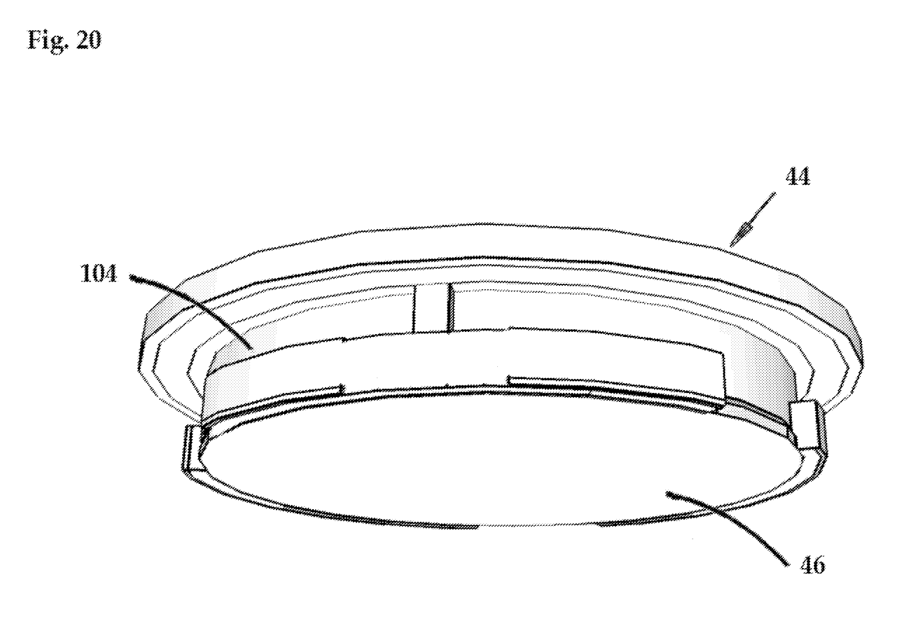

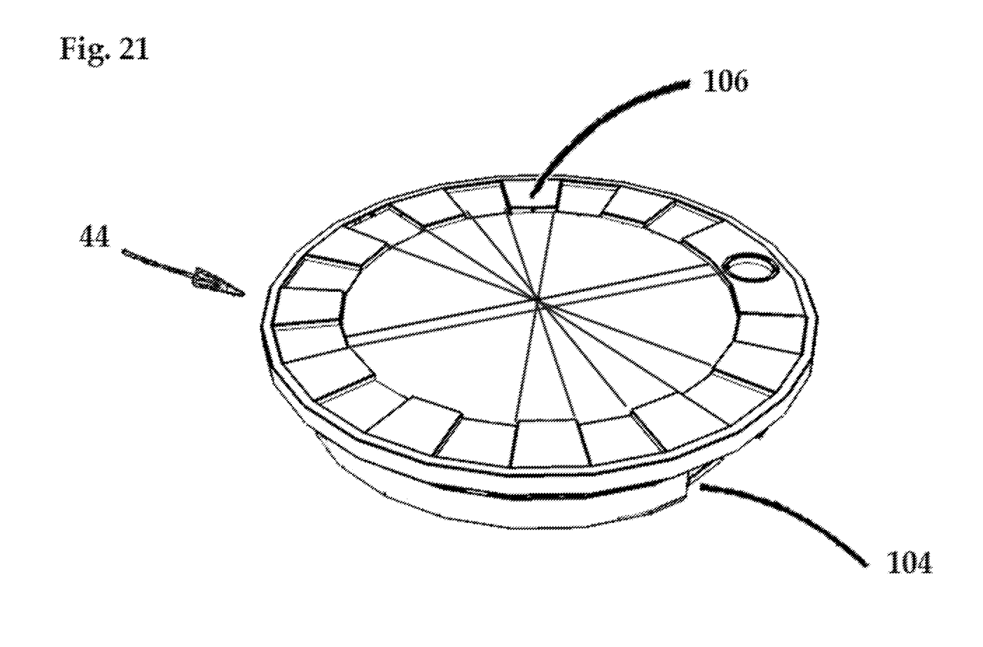

Our primary application of interest, the one which elicited the present invention, is a personal vaporizer device, specifically an electronic pipe like the one seen in FIG. 8. The stem portion of this ‘pipe’ would be made up of an electronic atomizer and a mouthpiece, while the pipe assembly described here is merely a source of power for that atomizer and a platform for further development, alternative circuit designs and additional features such as adjustable wattage, LEDs or other indicators. As seen in FIG. 7, this application requires: a pipe body 40 with openings for the chamber, shank, and pushbutton; a molded core support 42 which can maintain all parts in their appropriate relationships; a locking cap 44; a conductive disc 46; a battery 48; a fuse 50; switch magnets 52; switch arm 54; a switch to battery bracket 56 with spring; an attaching magnet 58; a pushbutton 60 with recess for magnet; a fuse spring 62 with lead; a switch contact plate 64 with lead; a shank to core lock cylinder 66; a fastening screw 68 for cylinder 66; a press fit atomizer connector 70 with integrated connections for two leads. FIGS. 9 through 21 illustrate this electronic pipe implementation in more detail.

The pipe body can be manufactured in much the same manner of traditional smoking pipes. In a preferred embodiment it is carved from wood, however it could also be stone, glass, polymer, etc. It should however meet certain specifications in order to accommodate the remaining parts which form the electronic pipe system. Core support 42 should include guides and niches for all remaining parts to interact. Cap 44 should include locks to mate with support 42 as well as a niche for conductive disc 46. In one embodiment, core 42 and cap 44 are additively manufactured of plastic. In other embodiments they may be ceramic, glass or any similar non-conductive material. In one embodiment, battery 48 is a rechargeable lithium ion cell. It could conceivably be any source of electricity which can fit within the core. In a preferred embodiment, fuse 50 is a low voltage automotive type. However, it could be any suitable fuse that can be accommodated by the core and enclosure. Magnets 52 and armature 54 are identical to those of previously described mechanisms. Battery spring bracket 56 is fashioned of conductive and magnetically active material with a spring attached to one end. It is designed to sit under magnets 52 and connect them electrically to the spring which will sit under battery 48 (we only need a normally open contact for this application.) Magnet 58 is identical to those previously described. In a preferred embodiment, pushbutton 60 is cut from wood, but it could be made of any similarly durable material.

Magnet 58 and pushbutton 60 are pressed and secured together as in previous embodiments and will form the point of user activation, protruding from the side of pipe body 40. Their modularity allows for easier assembly because pushbutton 60 can be attached after core support 42 is fitted, along with other components inside pipe body 40. Fuse spring with lead 62 is made of conductive material and will serve ultimately to connect fuse 50 to atomizer connector 70 while also forcing the top of fuse 50 into contact with disc 46. Switch contact plate 64 with lead is also made from conductive material and will serve to connect the switch mechanism to connector 70. Locking screw 68 will be used to secure locking sleeve 66 to core 42 through the shank of pipe body 40 before attaching modular pushbutton 60. Connector 70 is a standard atomizer connection for electronic cigarettes. It is modified only by the addition of two mating connectors for the leads, allowing for easier disassembly.

Assembly of the device requires first that all permanent electronic components are fitted and secured in the niches of core support 42. Fuse spring with lead 62 is secured within fuse chamber 74 and lead 82 extends through opening 72. Next switch contact plate with lead 64 is fastened into niche 76. Battery spring bracket 56 should then be inserted into niche 84 so that the spring is in the battery chamber. Switch magnets 52 can then be fixed within niche 92 and electrically connected to bracket 56 (we only need the normally open circuit for this application.) Finally switch arm 54 is fitted into niche 88 and atop magnets 52 completing the tactile switch apparatus and the core assembly. Next this is combined with the remaining components inside pipe body 40.

Begin by feeding leads 80 and 82 through the pipe chamber and pipe shank as core support 42 is inserted into pipe body 40. Leads 80 and 82 are then threaded through holes 98 and 100 in lock cylinder 66 as it is inserted into the pipe shank. With leads now held out of the way, screw 68 can be fastened through hole 102 of cylinder 66 and into securing point 78 of core support 42. This will pull the two sides together inside pipe body 40 and serve to stabilize the entire assembly. After this, leads 80 and 82 can be attached to atomizer connector 70 at 94 and 96. Then the connector is press fit into locking cylinder 66 completing the primary assembly. It should fit in such a way that it is not able to spin over time. Lastly conductive disc 46 is fastened into the bottom of cap 44 and external pushbutton 60 along with attaching magnet 58 is attached through the side of pipe body 40.

With these steps completed the device is now in a user ready state and battery 48 along with fuse 50 can be placed in their respective niches within the pipe core. Next, taking advantage of texture 106 on top of cap 44, the cap assembly is locked into place by pressing down and twisting locks 104 under teeth 86. This holds disc 46 firmly against the top of battery 48 as well as fuse 50, allowing positive current to flow first through disc 46 and fuse 50, then spring 62 and lead 82 into connector 70 where it will power the atomizer. This arrangement is preferred because in an over current situation the fuse would fail before anything else. On the return side of the connector, current will flow through lead 80 to plate 64 where it can be switched by the mechanism previously described. As user supplied pressure forces pushbutton 60 through pipe body 40 and into niche 90 it causes armature 54 to pivot on magnets 52 and strike switch plate 64 allowing current to flow through armature 54, magnets 52, and spring bracket 56 back to battery 48. This completes the circuit and when pressure is released, armature 54 will snap back into position on top of magnets 52, breaking the circuit.

The electronic pipe described holds several other key benefits over currently available models. Chief among these is its ease of use and maintenance. Battery 48 can be readily accessed by simply pressing and turning cap 44, releasing locks 104 from teeth 86. Fuse 50 can be accessed through the same opening and is intended to be a common automotive fuse, found at many service stations. The shank locking design of this pipe assembly means that interior components, while stabilized, remain fully accessible for cleaning or even complete replacement if necessary without the risk of damaging a highly valued or one of a kind pipe body.

Perhaps most importantly, the point of user activation is comfortably positioned on the side of pipe body 40 rather than on top of the chamber as with most current designs. This placement allows for more natural handling of the device and an experience more in keeping with traditional pipe smoking Additionally it leaves the cap free to be a primarily decorative component and a point of customization. The modular nature of the switch means that pushbutton 60 can simply be removed if one wishes to disable the device temporarily. This arrangement of components and these benefits are made possible largely by the modular tactile mechanism of the present invention.

While a very specific implementation has been described here, it is easy to imagine numerous and varied scenarios in which the present invention might be of considerable utility. A number of additional features such as voltage or wattage adjustments, led indicators etc. might be added to this basic pipe platform according to specific preferences. Further, modification of core 42 and cap 44 could easily adapt the pipe design into a cigar or cigarette style vaporizer, a pen light, or a number of other consumer electronics devices. Furthermore, the switch specifically and the tactile mechanism more generally could be employed in countless custom applications, particularly those of hobbyists and craftsmen who may be interested in durability and ease of maintenance. It should be understood that the specific examples given here are in no way meant to limit the following claims.

What is claimed:

1. A tactile mechanism comprising: an armature of magnetically active material; a supporting magnet which also acts as a fulcrum for the armature; a customizable supporting structure with guiding niches for the interacting parts; along with a modular, point of user activation to ease manual pivoting of the armature for tactile effect.

2. The mechanism of claim 1, further comprising two or more electrical contacts with the mechanism being used to alter continuity between the contacts.

3. A tactile switch adapted from the mechanism of claim 1 comprising; an armature of conductive and magnetically active material; at least one magnet upon which the armature rests and which also acts as a fulcrum for the armature; one electrical contact positioned near the tip of the armature and in the path of pivot such that, upon actuation the tip will strike it; additionally one or more electrical contacts positioned in individual electrical continuity with the magnet(s) at the opposite end; along with a customizable base structure as well as a customizable point of activation which, together support and guide the interacting elements to alter continuity between contacts. and a tactile response.

4. The switch of claim 2 when implemented as a means of activation for a personal vaporizer or simulated smoking device.

5. The switch of claim 3 when implemented as a means of activation for a personal vaporizer or simulated smoking device.

6. An electromechanical platform for development of electronic pipes or conversion of traditional pipes for use with personal vaporizers, comprising: a supporting core with locking cap; a locking mechanism which secures the core within the pipe cavity, easing disassembly and maintenance; along with the requisite electronics to activate and power a device of the user's choosing.

7. The device of claim 6 implemented with the switch of claim 2.

8. The device of claim 6 implemented with the switch of claim 3.
